(19) United States
(12) Patent Application Publication
(10) Pub. No.: US 2002/0152281 A1
(43) Pub. Date: Oct. 17, 2002

(54) Online device and method for downloading and sharing information by one touch

(76) Inventor: Ko-Chien Chuang, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/897,570

(22) Filed: Jul. 2, 2001

(30) Foreign Application Priority Data
Apr. 13, 2001 (TW) 090108947

(51) Int. Cl. G06F 15/16

(52) U.S. Cl. 709/217; 709/250

(57) ABSTRACT

An online device for communicating between an Internet and an information processor is disclosed. The online device includes a memory storing an online program, a starting program and a network address therein, a button outputting a control signal in response to a touch, a network linking device in communication with the Internet under control of the online program, a microprocessor in communication with the memory, the button, the network linking device and the information processor for processing the online program, the starting program and the network address in response to the control signal, wherein the online program is executed for linking the network linking device to a web site corresponding to the network address, and the starting program is executed for starting the information processor to read in a download information from the web site. The online device is independent from the information processor.

### FIELD OF THE INVENTION

The present invention relates to an online device, and more particularly to an online device used for communicating between an Internet and an information processor. The present invention also relates to an online method for communicating between an Internet and an information processor.

### BACKGROUND OF THE INVENTION

Along with the quick development of Internet, it becomes a routine work for different information processors such as a personal computer (PC), a personal digital assistant (PDA), and a MPEG Layer (MP) player to access the required data by networking. An information exchanging device so called as an access point is developed for linking the information processor to the Internet. As shown in FIG. 1A, an access point 10 is co-worked with a plurality of information processors 11. FIG. 1B is a flow chart illustrating an online procedure by steps according to the prior art. First of all, an information processor such as a personal computer is turned on by the user. A network linking device of the access point 10 such as a modem or a network interface card is started by an operating interface of the personal computer to link to the Internet. After linking to the Internet, it is necessary to input a network address via the operating interface by the user for further linking to a desired web site. Hence, for the user who is not familiar with the personal computer operation, the complicated online procedure is really troublesome.

Therefore, the purpose of the present invention is to develop a device and a method to deal with the above situations encountered in the prior art.

### SUMMARY OF THE INVENTION

It is therefore an object of the present invention to provide an online device and method for easily and conveniently networking by touching a button.

It is another object of the present invention to provide an online device and method for quickly and conveniently accessing the data in the network.

According to an aspect of the present invention, an online device for communicating between an Internet and an information processor including a memory storing an online program, a starting program and a network address therein, a button outputting a control signal in response to a touch, a network linking device in communication with the Internet under the control of the online program, a microprocessor in communication with the memory, the button, the network linking device and the information processor for executing the online program, the starting program and the network address stored in the memory in response to the control signal, wherein the online program and the network address are executed for linking the network linking device to a web site which is corresponded of the network address of the Internet, and the starting program is executed for starting the information processor to read in a download information from the web site, and a casing separated from a case of the information processor for accommodating the memory, the button, the network linking device and the microprocessor.

Preferably, the memory is a nonvolatile memory, and more preferably, a flash memory.

For example, the information processor can be a personal computer, a personal digital assistant (PDA), or a digital player.

Preferably, the online program, starting program and the network address stored in the memory are changeable and set by a user.

For example, the network linking device can be a modem, a network interface card or a set-top box.

Preferably, the online device further includes a wireless transmission module signaling linked between the microprocessor and the information processor for wirelessly transmitting a signal between the microprocessor and the information processor. For example, the wireless transmission module can be a Bluetooth wireless transmission module or an infrared-ray transmission module.

According to another aspect of the present invention, there is provided an online method for communicating between an Internet and an information processor. The online method includes steps of presetting an online program, a starting program and a network address corresponding to a control signal, outputting the control signal when a user touches a button and automatically executing the online program, the starting program and the network address in response to the control signal, wherein the online program and the network address are executed for linking the network linking device to a web site which is corresponded of the network address of the Internet, and the starting program is executed for starting the information processor to read in a download information from the web site.

For example, the information processor can be a personal computer, a personal digital assistant (PDA) or a digital player.

The present invention may best be understood through the following description with reference to the accompanying drawings, in which:

### BRIEF DESCRIPTION OF THE DRAWINGS

FIG. 1A is a block diagram illustrating an access point co-working with a plurality of information processors;

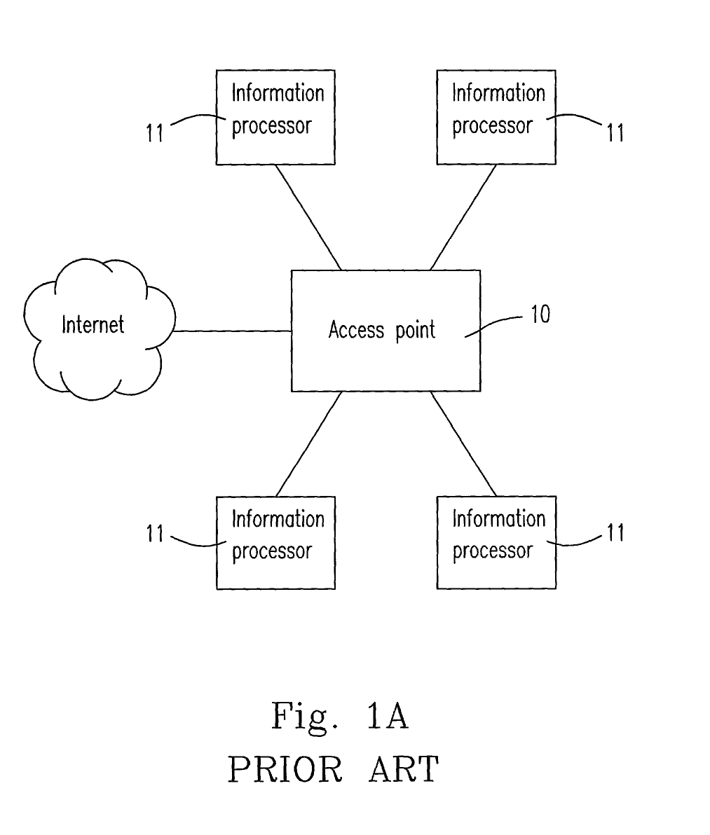

FIG. 1B is a flow chart illustrating an online procedure by steps according to the prior art;

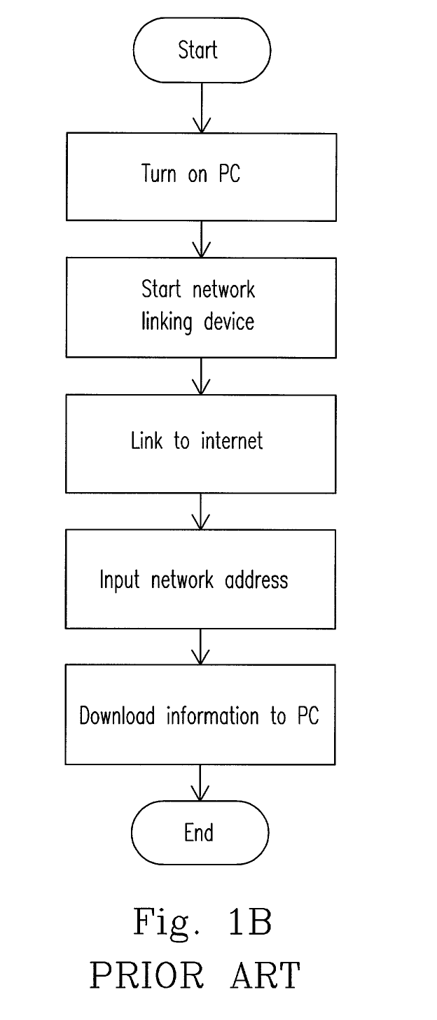

FIG. 2 is a block diagram illustrating a preferred embodiment of an online device according to the present invention; and

FIG. 3 is a block diagram illustrating another preferred embodiment of an online device according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

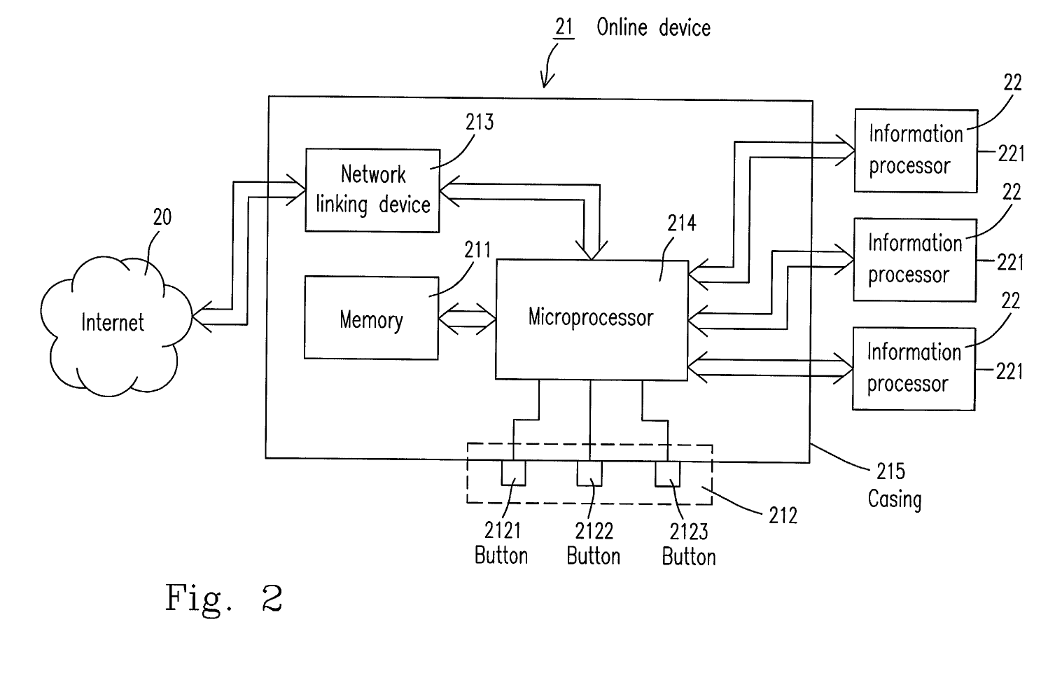

FIG. 2 is a block diagram illustrating a preferred embodiment of an online device according to the present invention. As shown in FIG. 2, the online device can be applied between an Internet 20 and information processors 22, e.g. a personal computer, a personal digital assistant (PDA) or a digital player such as a MPEG Audio Layer-3 player (MP3). The online device 21 includes a memory 211, a button set 212, a network linking device 213, and a microprocessor 214 accommodated in a casing 215. The online device 21 and each information processor 22 are independent from each other. That is, the casing 215 is separated from a case 221 of the information processor 22, and the two devices are operated independently. The memory 211 employs a nonvolatile memory, e.g. a flash memory, because the memory storing function won't be affected under without power condition. The button set 212 further including a plurality of buttons 2121, 2122, 2123 in order to be simultaneously set plural desired online information sets. In addition, the network linking device 213 is a modem linking to the Internet 20 via a public switched telephone network (PSTN), a network interface card linking to the Internet 20 via an Ethernet, or a set-top box linking to the Internet 20 via a cable depending on the different particular requirements.

Moreover, an online program, a starting program and a network address are stored in the memory 211 and can be set by a user via an input interface of the information processor, such as a keyboard of a personal computer or an input pad of a personal digital assistant, according to the user's requirement. When the user touches one of the buttons 2121, 2122, 2123 disposed on the casing 215 to output a control signal to the microprocessor 214, the online program, the starting program and the network address stored in the memory 211 which correspond to the selected button are executed by the microprocessor 214 in response to the control signal. The online program is executed for linking the network linking device 213 to a web site of the Internet corresponding to the network address. Furthermore, the starting program is executed for starting associated information processors 22 to read in a download information from the web site.

Hereinafter, an example is given to further describe the above embodiment so as to facilitate the understanding of the invention. The network linking device 213 is the modem linking to the Internet 20 via the public switched telephone network (PSTN), the information processor 22 is the personal digital assistant (PDA), and the online program, the starting program and the network address corresponding to the button 2121 are respectively set to be a linking program designated to link to the America Online (AOL), a start instruction for starting the personal digital assistant, and a network address of http://avantgo.com. Hence, the user only has to push or touch the button 2121 to automatically link to AOL by executing the online program, and start one or more personal digital assistants to a working status by executing the starting program via the online device 21 of the present invention. Furthermore, after online, the network address will lead the online device 21 to enter a channel of the AvantGo web site, such as The Wall Street Journal, and download information from the web site. The information is transmitted any associated personal digital assistants 22.

For another example, the online program, the starting program and the network address corresponding to the button 2122 are similar to those of the above example except that the network address is an e-mail address with a log-in information. Hence, the user only has to push or touch the button 2122 to automatically link to AOL by executing the online program and start one or more personal digital assistants to a working status by executing the starting program via the online device 21 of the present invention. Furthermore, after online, the e-mail address and the log-in information will be entered to reach an e-mail box and download an e-mail information which is further transmitted to the associated personal digital assistants.

For an additional example, the online program, the starting program and the network address corresponding to the button 2123 are set to be a linking program to America Online (AOL), a start instruction for starting the MPEG Layer-3 (MP3) player and a network address for a music download zone with a log-in information, respectively. Hence, the user only has to push or touch the button 2123 to automatically link to AOL by executing the online program and start one or more than one MP3 players to a working status by executing the starting program via the online device 21 of the present invention. Furthermore, after online, the network address for a music download zone and the log-in information will be executed to automatically enter the music download zone of a music web site and download a song for further transmitting to the one or more than one MP3 players.

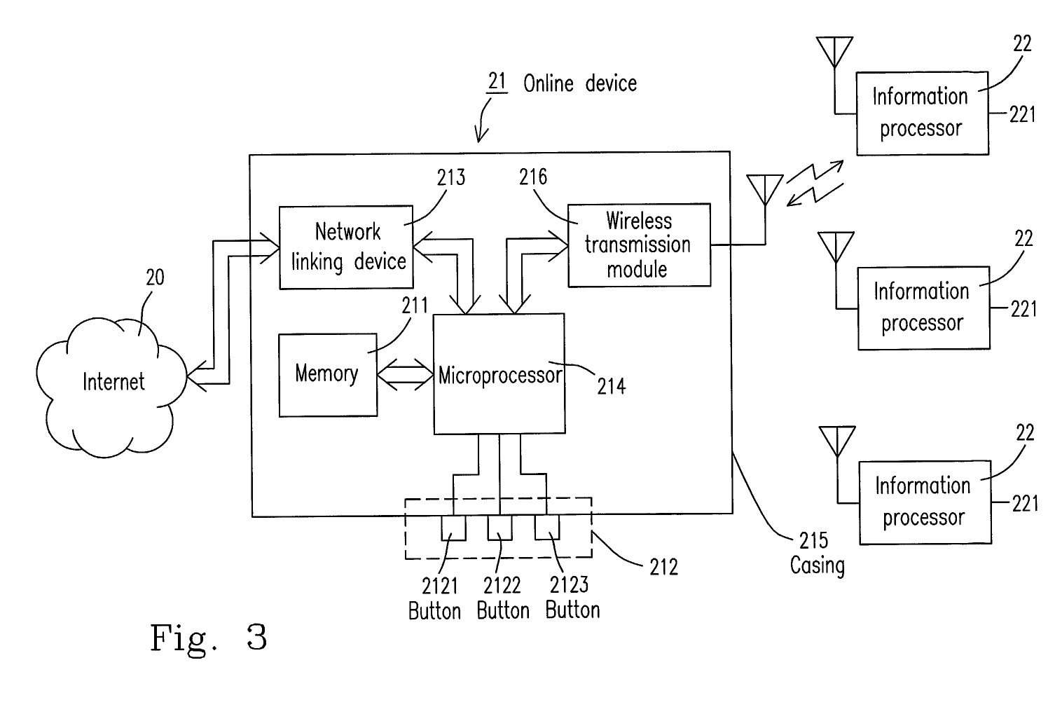

In addition, for convenience, a wireless transmission module 216 is used for transmitting signals between the online device 21 and the information processors 22, as shown in FIG. 3. Thus, the inconvenience resulting from plugging-in or -out the signal line can be avoided. The wireless transmission module 216 can be a Bluetooth, an infrared-ray wireless transmission module, or any other suitable wireless transmission device.

In sum, the online device or method according to the present invention provide a simple way for online to avoid the complicated prior art steps. That is, the user only has to push or touch one button which is pre-set the required information to link to a desired web site of the Internet, and then the operations for downloading personal information such as e-mail, music or note and transmitting the information to one or plural information processors 22 can be automatically started. Therefore, the present invention provides a quick and convenient network access function for users.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An online device for communicating between an Internet and an information processor, comprising:
a memory storing an online program, a starting program and a network address therein;
a button outputting a control signal in response to a touch;
a network linking device in communication with said Internet under the control of said online program;
a microprocessor in communication with said memory, said button, said network linking device and said information processor for processing said online program, said starting program and said network address stored in said memory in response to said control signal, wherein said online program is executed for linking said network linking device to a web site which corresponds to said network address of said Internet, and said starting program is executed for starting said information processor to read in a download information from said web site; and
a casing separated from a case of said information processor for accommodating said memory, said button, said network linking device and said microprocessor.

2. The online device according to claim 1 wherein said memory is a nonvolatile memory.

3. The online device according to claim 2 wherein said nonvolatile memory is a flash memory.

4. The online device according to claim 1 wherein said information processor is a personal computer.

5. The online device according to claim 1, wherein said information processor is a personal digital assistant (PDA).

6. The online device according to claim 1 wherein said information processor is a digital player.

7. The online device according to claim 1 wherein said online program, said starting program and said network address stored in said memory are changeable and set by a user.

8. The online device according to claim 1 wherein said network linking device is a modem.

9. The online device according to claim 1 wherein said network linking device is a network interface card.

10. The online device according to claim 1 wherein said network linking device is a set-top box.

11. The online device according to claim 1 further comprising a wireless transmission module in communication with said microprocessor and said information processor for wirelessly transmitting a signal between said microprocessor and said information processor.

12. The online device according to claim 11 wherein said wireless transmission module is a Bluetooth wireless transmission module.

13. The online device according to claim 11, wherein said wireless transmission module is an infrared-ray transmission module.

14. An online method for communicating between an Internet and an information processor, comprising steps of:
presetting an online program, a starting program and a network address corresponding to a control signal;
outputting said control signal when a user touches a button; and
automatically processing said online program, said starting program and said network address in response to said control signal, wherein said online program is executed for linking said network linking device to a web site which corresponds to said network address of said Internet, and said starting program is executed for starting said information processor to read in a download information from said web site.

15. The online method according to claim 14, wherein said information processor is a personal computer.

16. The online method according to claim 14, wherein said information processor is a personal digital assistant (PDA).

17. The online method according to claim 14, wherein said information processor is a digital player.
